(19) United States
(12) Patent Application Publication
(10) Pub. No.: US 2012/0321112 A1
(43) Pub. Date: Dec. 20, 2012

(54) SELECTING A DIGITAL STREAM BASED ON AN AUDIO SAMPLE

(75) Inventors: Emily Clark Schubert, San Jose, CA (US); Gregory F. Hughes, Cupertino, CA (US); Edwin Foo, San Mateo, CA (US)

(73) Assignee: Apple Inc., Cupertino, CA (US)

(21) Appl. No.: 13/162,488

(22) Filed: Jun. 16, 2011

(51) Int. Cl. H04R 25/00; G06F 17/00

(52) U.S. Cl. 381/312; 700/94

(57) ABSTRACT

One or more digital streams can be selected from a number of digital streams using a portable device. Selection of the digital streams can be based on a comparison between the number of digital streams and an audio sample received via a microphone. Selection of the digital streams can additionally or alternatively be based on the signal strength of wireless connections, the direction in which the portable device is pointed, images obtained from a camera, etc. At least one of the selected digital streams can thereafter be transmitted to a hearing aid device connected to the portable device.

### BACKGROUND

The present disclosure relates generally to wireless communication between computing devices and more particularly to the selection of one or more digital streams from a number of digital streams by a portable device.

Computing devices have been in use for several decades. Examples of computing devices include, for example, desktop computers, laptop computers, mobile phones, smartphones, tablet devices, portable multimedia players, devices integrated into automobiles, and/or the like. Computing devices can be used for performing a wide variety of tasks, from the simple to the most complex. In some embodiments, computing devices can have weight and size characteristics such that the devices are portable or easily moved.

In some cases, portable computing devices can be used to help those with hearing aids better perceive the sounds being projected around them. For example, a television can project audio through its speakers and, at the same time, transmit a corresponding digital audio stream. A portable device connected to a hearing aid can receive the digital audio stream and transmit the stream to the hearing aid. Audio generated using the digital stream can be high in quality, especially because the stream does not suffer from the effects of distance, background noise, etc.

### BRIEF SUMMARY

According to various embodiments of the present invention, one or more digital streams can be selected from a number of received digital streams by a portable device. At least one of the digital streams can thereafter be transmitted to a hearing aid device connected to the portable device.

Illustratively, a portable device can be configured to receive a set of digital streams over one or more wireless connections. In some embodiments, upon receiving the digital streams, the portable device can automatically select a single digital stream from the set to be provided to a connected hearing aid device. In other embodiments, the portable device can select a subset of the digital streams in the set and provide, to a user, a listing referencing the subset. The user can thereafter select a single digital stream from the subset to be provided to a hearing aid connected to the portable device.

The portable device can select the one or more digital streams in any suitable manner. For example, the portable device can select a digital stream based on the correlation of the stream to an audio sample received from a microphone. As another example, the portable device can select a digital stream based on the signal strength of the wireless connection with which the stream is associated. As yet another example, the portable device can select a digital stream based on the direction in which the portable device is currently pointed. As still another example, the portable device can select a digital stream based on an image captured by a camera.

These and other embodiments of the invention along with many of its advantages and features are described in more detail in conjunction with the text below and attached figures.

### BRIEF DESCRIPTION

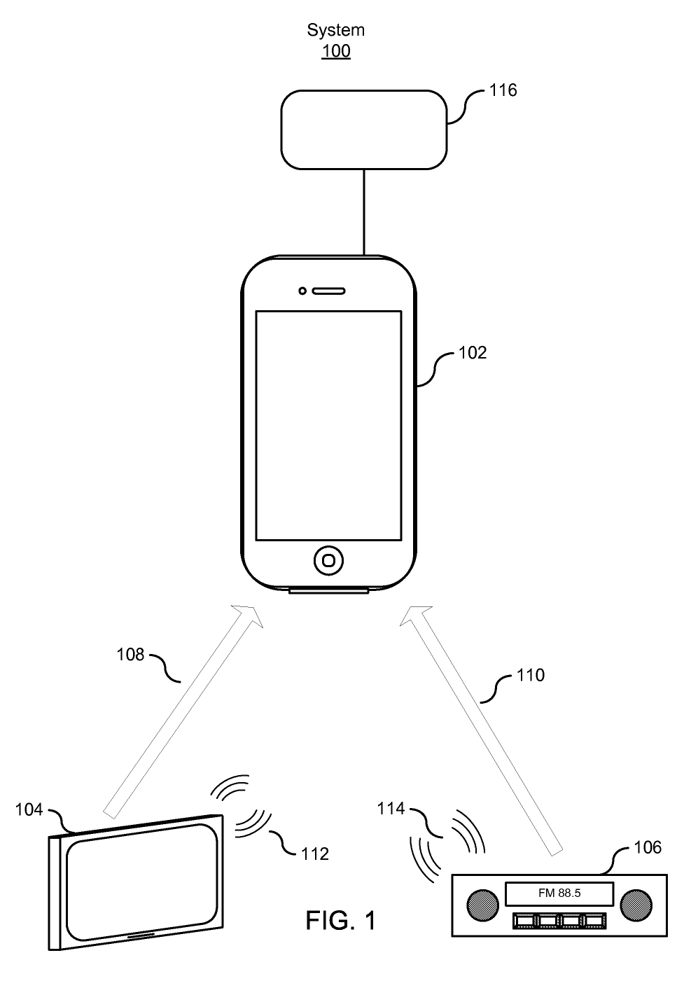

FIG. 1 illustrates a system including a portable device, a hearing aid device, and two devices capable of transmitting digital streams according to an embodiment of the present invention.

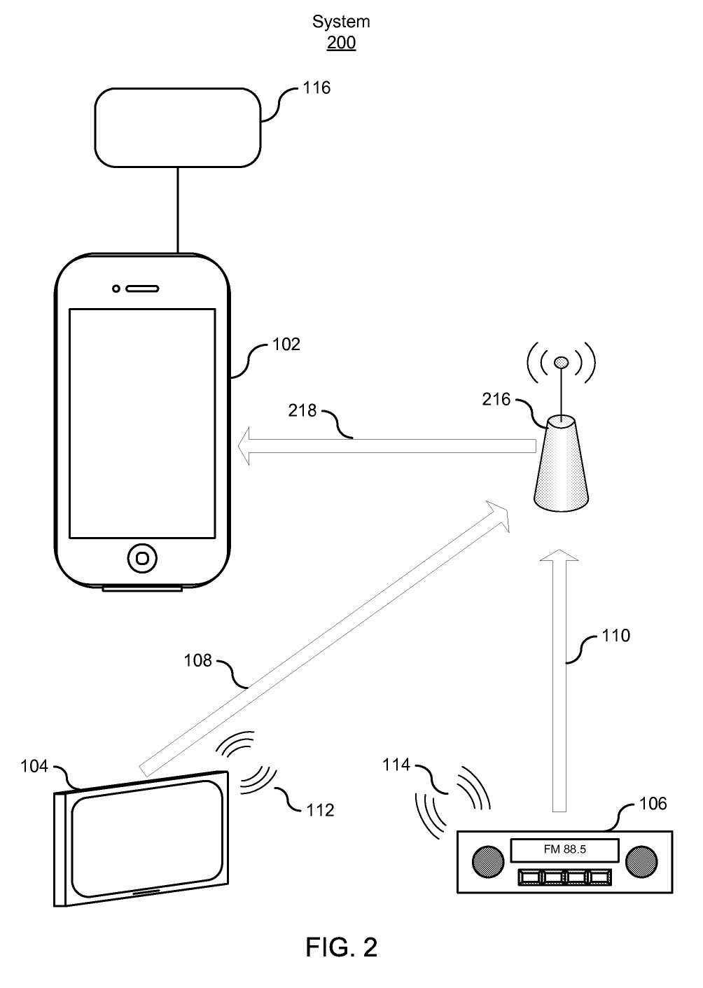

FIG. 2 illustrates a system including a portable device, a hearing aid device, an access point, and two devices capable of transmitting digital streams according to another embodiment of the present invention.

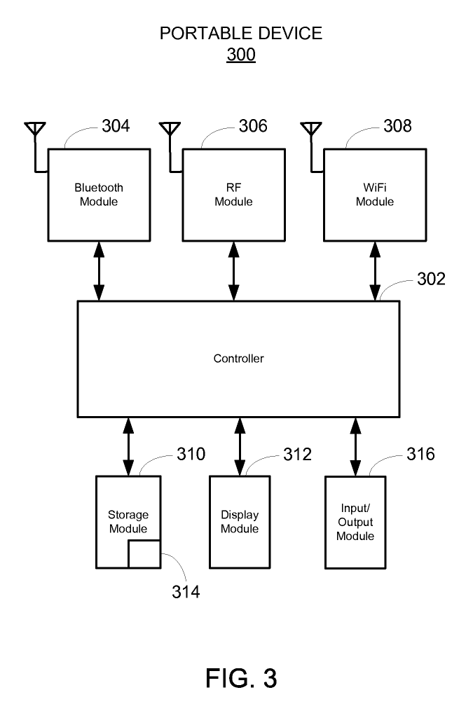

FIG. 3 illustrates an exemplary portable device according to an embodiment of the present invention.

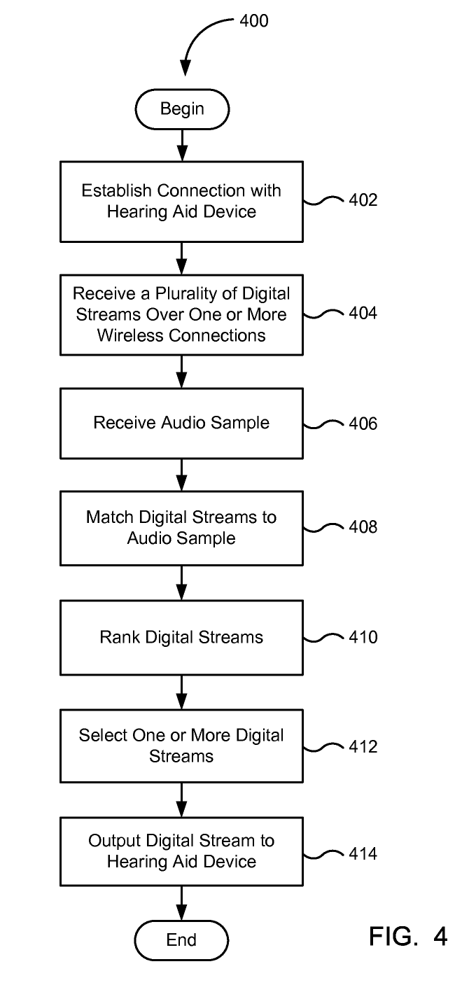

FIG. 4 is a flow diagram of a process usable by a portable device for selecting one or more digital streams based on an audio sample according to an embodiment of the present invention.

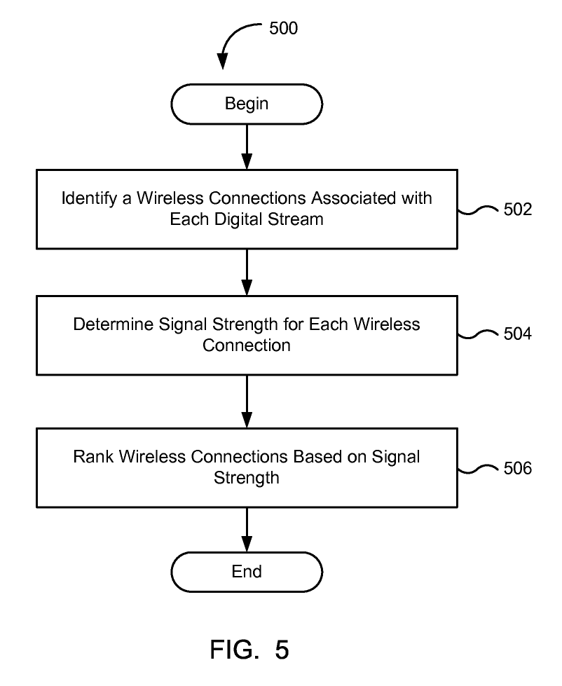

FIG. 5 is a flow diagram of a process usable by a portable device for ranking and/or selecting a digital stream based on the signal strength of one or more wireless connections according to an embodiment of the present invention.

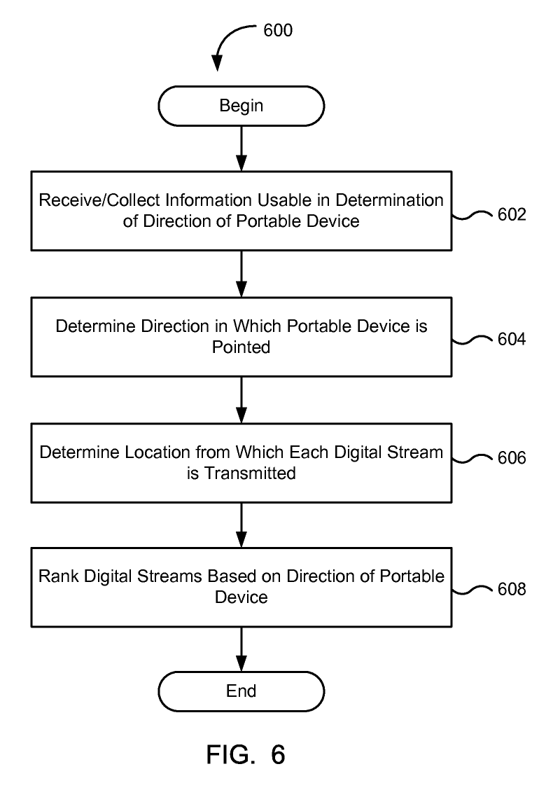

FIG. 6 is a flow diagram of a process usable by a portable device for ranking and/or selecting a digital stream based on the direction in which the portable device is currently pointed according to an embodiment of the present invention.

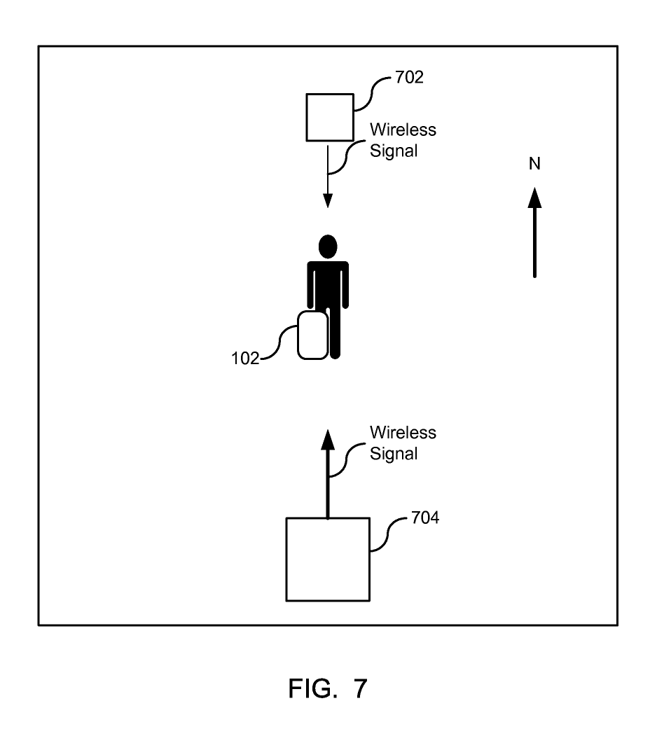

FIG. 7 illustrates an environment including a television, a radio system, and a portable device according to an embodiment of the present invention.

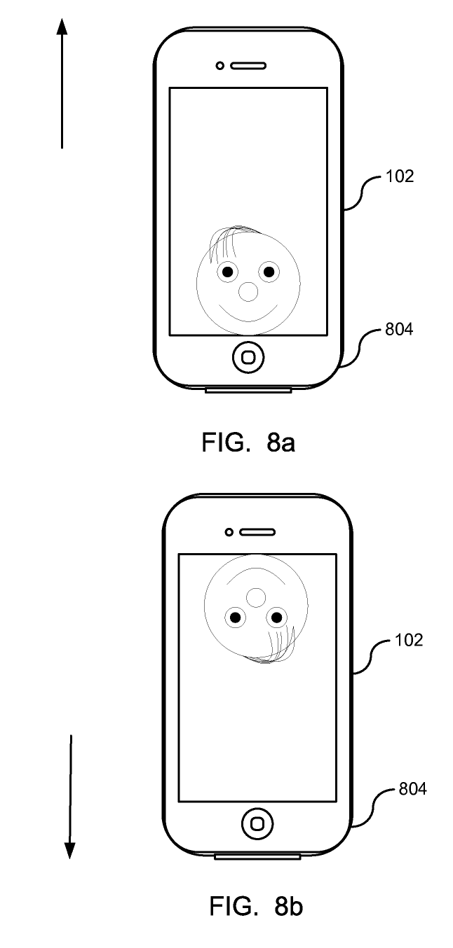

FIGS. 8a and 8b illustrate exemplary images taken by a camera that can be used to determine the direction in which a portable device is pointed according to an embodiment of the present invention.

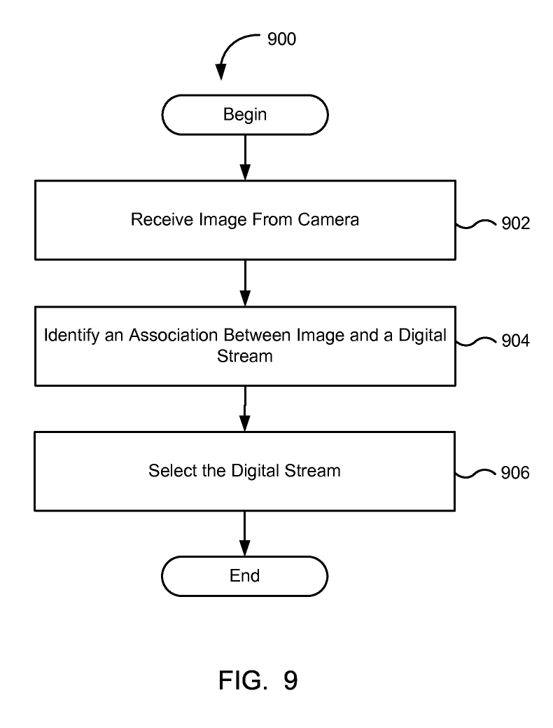

FIG. 9 is a flow diagram of a process usable by a portable device for selecting a digital stream based on an image captured by a camera according to an embodiment of the present invention.

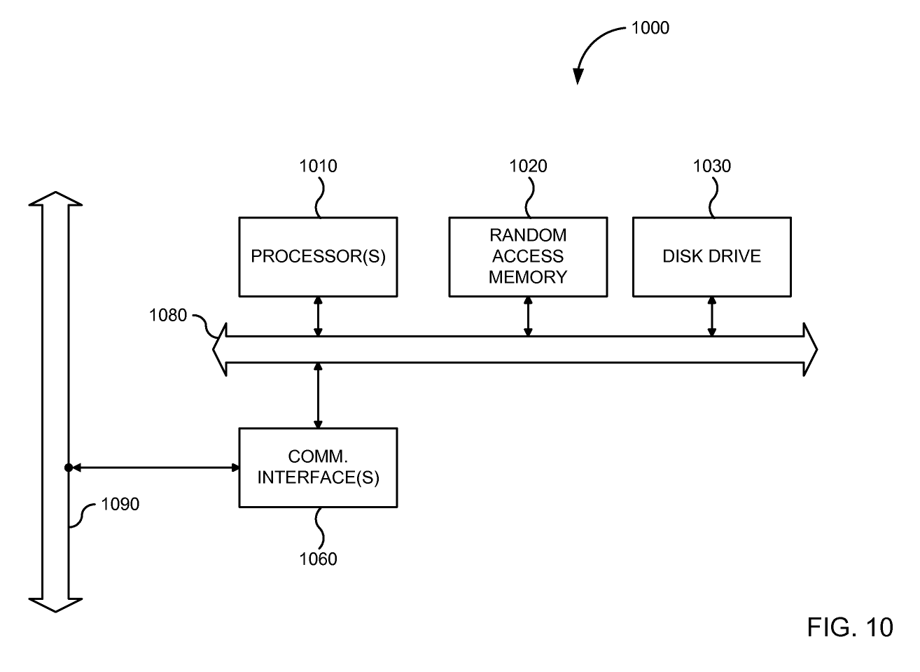

FIG. 10 is a simplified block diagram of a computer system that can be used in embodiments of the present invention.

### DETAILED DESCRIPTION

Some embodiments of the present invention provide techniques to select one or more digital streams from a number of digital streams using a portable device.

Illustratively, a portable device can be configured to receive a set of digital streams (e.g., digital audio streams) over one or more wireless connections e.g., Bluetooth, Institute of Electrical and Electronics Engineers (IEEE) 802.11 family standards, etc. In some embodiments, upon receiving the digital streams, the portable device can automatically select a particular digital stream from the set and transmit the digital stream to a connected hearing aid device. In other embodiments, the portable device can select a subset of the digital streams in the set. Thereafter, the portable device can provide a listing referencing the subset to a user. The user can subsequently select a digital stream from the subset to be provided to a connected hearing aid device.

The portable device can select the one or more digital streams in any suitable manner. For example, the portable device can select a digital stream based on a received audio sample. In particular, the portable device can receive an audio sample from a microphone or other suitable recording device. The portable device can subsequently determine a correlation between each of the received digital streams and the audio sample. Thereafter, the portable device can select one or more of the digital streams based on each stream's correlation to the audio sample.

As another example, the portable device can select a digital stream based on the signal strengths of the wireless connections over which the set of digital streams are being transmitted. In particular, the portable device can select a digital stream being transmitted over a wireless connection having the strongest signal.

As still another example, the portable device can select a digital stream based on the direction that a portable device or microphone connected to the portable device is currently pointed. In some embodiments, the direction of the portable device can be determined based on the global positioning system (GPS) coordinates of the portable device, information collected from a magnometer embedded in the portable device, the strength of the wireless signals being received by the portable device, the images captured by a camera module embedded in the portable device, yet to be invented positioning technologies, and/or the like.

As yet another example, the portable device can select a digital stream based on an image captured by a camera embedded in or connected to the portable device. In some instances, a camera of the portable device can be used to take a picture of a movie being presented on a television set. The portable device can process the picture and identify the specific movie being presented on the television set. Thereafter, the portable device can determine whether any received digital streams are associated with the identified movie. If an associated digital stream is found, the portable device can select the digital stream. In other instances, a camera of the portable device can be used to take a picture of a person. The portable device can process the picture to identify the specific person shown in the picture. Thereafter, the portable device can determine whether any received digital streams are associated with the identified person. If an associated digital stream is found, the portable device can select the digital stream. An associated digital stream can be, for example, a digital audio stream generated by the identified person speaking into a microphone connected to a streaming device (e.g., another portable device).

FIG. 1 illustrates a system 100 including a portable device 102, a hearing aid device 116, and streaming devices 104 and 106 (e.g., a television, radio, etc.).

Portable device 102 can be any suitable device for receiving digital streams. For example, portable device 102 can be a device with a wireless interface, such as a laptop computer, a tablet device, a multi-function device, a mobile phone, a portable gaming device, a portable multimedia player, a portable music player, a portable digital stream receiver, a storage device, a camera, a remote control, a personal access point, a personal digital assistant (PDA), a household device, and/or any portable or non-portable electro-mechanical device and/or the like. For example, portable device 300 can be an iPod®, iPhone®, or iPad® device available from Apple Inc. of Cupertino, Calif.

Streaming devices 104 and 106 can be any suitable devices capable of transmitting a digital stream. For example, a streaming device can be a device with a wireless interface, such as a desktop computer, a laptop computer, a tablet device, a multi-function device, a mobile phone, a portable gaming device, a portable multimedia player, a portable music player, a camera, a personal digital assistant (PDA), a television, a radio, a digital video recorder (DVR), a multimedia distribution system, a network attached storage device, a telephone, a voice over IP (VOIP) based telephone, a video teleconferencing system, a projector, a docking system, a digital image frame, an automobile, an in-flight entertainment system, a speaker system, a PA system, an intercom system, a household appliance or other device, and/or any portable or non-portable electro-mechanical device and/or the like. For example, a streaming device can be an iPod®, iPhone®, or iPad® device available from Apple Inc. of Cupertino, Calif.

Hearing aid device 116 can be any suitable device for projecting, amplifying, and/or modulating a digital and/or analog audio signal. In some embodiments, hearing aid device 116 can be fit or worn in or behind a user's ear. Conventional hearing aid devices can be used.

In some embodiments, portable device 102 and hearing aid device 116 can be in operative communication over a suitable wired or wireless connection. For example, portable device 102 and hearing aid device 116 can communicate over a wireless Bluetooth or Bluetooth Low Energy (LE) connection. As another example, portable device 102 and hearing aid device 116 can communicate over a physical cable or wire.

In certain embodiments, portable device 102 can be in operative communication with each of streaming devices 104 and 106 over a wireless connection (e.g., wireless connections 108 and 110). For example, portable device 102 can communicate with streaming device 104 over a Bluetooth LE connection, and with streaming device 106 over an ad-hoc WiFi (802.11 family standards) connection.

In certain embodiments, streaming devices 104 and 106 can each be configured to transmit digital streams to portable device 102 over their respective wireless connections. A digital stream can, according to some embodiments, include or be a digital audio signal and/or a digital audiovisual signal. The digital stream can additionally include identifiers, metadata and/or other information. In some embodiments, each of streaming devices 104 and 106 can additionally include one or more speakers (not shown). The streaming devices 104 and 106 can use the speakers to broadcast audio projections (e.g., audio projections 112 and 114). Each audio projection can correspond to a digital stream being transmitted by streaming devices 104 and 106 to portable device 102. In some embodiments, each of streaming devices 104 and 106 can also transmit other digital streams that do not correspond to the audio projections broadcasted from each device's speakers. For example, each of streaming devices 104 and 106 can additionally transmit streams in other languages or tailored for specific disabilities (e.g., descriptive video).

FIG. 2 illustrates a system 200 including a portable device 102, an access point 216, a hearing aid device 116, and streaming devices 104 and 106. System 200 can be similar to system 100 shown in FIG. 1, except that system 200 can include access point 216.

Access point 216 can be any suitable device for receiving, processing, and transmitting data. Access point 216 can be, for example, a network switch, a wireless router, another portable device (e.g., an iPhone®) and/or the like. In some embodiments, access point 216 can include, among other components, a WiFi interface for facilitating wireless communications.

As shown in FIG. 2, streaming devices 104 and 106 can be in operative communication with access point 216 over connections 108 and 110. Connections 108 and 110 can each be a suitable wired and/or wireless connection. For example, streaming devices 104 and 106 can each be connected to access point 216 over WiFi connections. As shown in FIG. 2, portable device 102 can be in operative communication with access point 216 over connection 218. Connection 218 can be any suitable wireless connection, such as a WiFi connection.

In some embodiments, each of streaming devices 104 and 106 can transmit their respective digital streams to access point 216 over connections 108 and 110. Upon receiving the digital streams, access point 216 can transmit the streams to portable device 102 over wireless connection 218.

It will be appreciated that the devices shown in FIGS. 1 and 2 are illustrative and that variations and modifications are possible. For example, although the system of FIGS. 1 and 2 only show one primary portable device, two streaming devices, and one hearing aid device, any suitable number of these entities (including zero) can be included. As an example, system 100 of FIG. 1 can include ten digital streaming devices. As another example, system 200 can include some streaming devices directly transmitting digital streams to portable device 102 and other streaming devices indirectly transmitting digital streams to portable device 102 via access point 216.

Furthermore, while embodiments described herein are primarily directed at the transmission of a selected digital stream to a hearing aid device, embodiments can be used to transmit digital streams to any number of other devices. For example, embodiments can be used to transmit a selected digital stream to a headphone, a personal speaker system, a portable device headset (e.g., a Bluetooth headset), etc.

FIG. 3 is a block diagram showing an exemplary portable device according to an embodiment. Portable device 300 can include a controller 302, a Bluetooth module 304, an RF module 306, a WiFi module 308, a storage module 310, a display module 312, and input/output module 316. According to some embodiments, portable device 300 can be a sufficient size, dimension, and weight to enable the device to be easily moved by a user. For example, portable device 300 can be pocket size or easily held within the palm of the hand. In some embodiments, the various components (e.g., controller 302, Bluetooth module 304, etc.) of portable device 300 can be enclosed within a suitable device housing.

Controller 302, which can be implemented as one or more integrated circuits, can control and manage the overall operation of portable device 300. For example, controller 302 can perform various tasks, such as retrieving various assets that can be stored in storage module 310, accessing the functionalities of various modules (e.g., interacting with other Bluetooth enabled devices via Bluetooth module 304), executing various software programs (e.g., operating systems and applications) residing on storage module 310, processing digital streams, processing audio samples, performing comparisons between digital streams and audio samples, determining the direction in which the portable device is pointed, determining the signal strength of wireless connections, performing image recognition, and so on. In some embodiments, controller 302 can include one or more processors (e.g., microprocessors or microcontrollers) configured to execute machine-readable instructions. For example, controller 302 can include a single chip applications processor. Controller 302 can further be connected to storage module 310 in any suitable manner.

Bluetooth module 304 can include any suitable combinations of hardware for performing wireless communications with other Bluetooth enabled devices and allows an RF signal to be exchanged between controller 302 and other Bluetooth enabled devices. In some embodiments, Bluetooth module 304 can perform such wireless communications according to standard Bluetooth Basic Rate/Enhanced Data Rate (BR/EDR) and/or Bluetooth Low Energy (LE) standards.

For example, Bluetooth module 304 can include suitable hardware for performing device discovery, connection establishment, and communication based on only Bluetooth LE (e.g., single mode operation). As another example, Bluetooth module 304 can include suitable hardware for device discovery, connection establishment, and communication based on both standard Bluetooth BR/EDR and Bluetooth LE (e.g., dual mode operation). As still another example, Bluetooth module 304 can include suitable hardware for device discovery, connection establishment, and communication based only on standard Bluetooth BR/EDR. In some embodiments, Bluetooth module 304 can be used to receive one or more digital streams from one or more streaming devices and/or access points.

RF module 306 can include any suitable combinations of hardware for performing wireless communications with wireless voice and/or data networks. For example, RF module 306 can include a RF transceiver (e.g., using mobile telephone technology such as GSM or CDMA, advanced data network technology such as 3G or EDGE) that enables a user of portable device 300 to place telephone calls over a wireless voice network.

WiFi module 308 can include any suitable combinations of hardware for performing WiFi (e.g., IEEE 802.11 family standards) based communications with other WiFi enabled devices. In some embodiments, WiFi module 308 can be used to receive one or more digital streams. Illustratively, WiFi module 308 can be used to receive one or more digital streams being transmitted by one or more streaming devices and/or access points.

Storage module 310 can be implemented, e.g., using disk, flash memory, random access memory (RAM), hybrid types of memory, optical disc drives or any other storage medium that can store program code and/or data. Storage module 310 can store software programs 314 that are executable by controller 302, including operating systems, applications, and related program code. In some embodiments, storage module 310 can include a suitable set of instructions, executable by controller 302, for performing image recognition, sound recognition, and/or the like.

Software programs 314 (also referred to as software or apps herein) can include any program executable by controller 302. In some embodiments, certain software programs can be installed on portable device 300 by its manufacturer, while other software programs can be installed by a user. Examples of software programs 314 can include operating systems, vehicle control applications, productivity applications, video game applications, personal information management applications, applications for playing media assets and/or navigating a media asset database, applications for controlling a telephone interface to place and/or receive calls, applications for receiving, selecting and transmitting digital streams, and so on. Certain software programs 314 can provide communication with and/or control of portable devices, and certain software programs 314 can be responsive to control signals or other input from portable device 300.

Display module 312 can be implemented as a CRT display, an LCD display (e.g., touch screen), a plasma display, a direct-projection or rear-projection DLP, a microdisplay, and/or the like. In various embodiments, display module 312 may be used to visually display user interfaces, images, and/or the like. In some embodiments, display module 312 can also be configured to receive input from a user of portable device 300. For example, display module 312 can be an LCD-based touch screen. During operation, display module 312 can present graphical user interfaces to a user and also receive inputs (e.g., finger taps) from the user. In some embodiments, display module 312 can provide visual user feedback indicating the audio being captured by a microphone or other suitable sound capture device.

Input/Output module 316 can be implemented as one or more input and/or output devices. Illustratively, input/output module 316 can include a touch screen (e.g., LCD based touch screen), a microphone, a camera, a voice command system, a keyboard, a computer mouse, a trackball, a wireless remote, a network interface, a connector interface, and/or the like. Input/Output module 316 can allow a user to provide inputs to invoke the functionality of controller 302. For example, input/output module 316 can include a microphone. The microphone can be configured to periodically or continuously detect and capture a sound or audio sample from the environment surrounding portable device 300. The captured audio sample can be used by controller 302 to select one or more received digital streams. As another example, input/output module 316 can include a camera. The camera can be configured to capture images. The images can also be used by controller 302 to select one or more received digital streams.

In some embodiments, portable device 300 can include additional modules not shown in FIG. 3, such as global positioning system (GPS) modules, battery modules, connector modules, three-dimensional video processing modules, magnometer modules, three-dimensional gyroscope modules, acceleration detection modules, orientation modules, and/or the like. For example, portable device 300 can include a magnometer module and a three-dimensional gyroscope module. The modules can be used to determine the direction in which portable device 300 is oriented. Illustratively, controller 302 can receive measurements and/or other readings from a magnometer module and a three-dimensional gyroscope module. Controller 302 can use the measurements and/or other readings to determine the direction in which the portable device is currently pointed.

It will be appreciated that the portable device shown in FIG. 3 is illustrative and that variations and modifications are possible. For example, certain modules can be removed, added, altered, changed, combined, etc. Further, while the portable device shown in FIG. 3 has been described with reference to particular blocks representing certain modules and a controller, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Examples of processes that can be used to select a digital stream from a number of digital streams using a portable device will now be described.

FIG. 4 is a flow diagram of a process 400 for selecting a digital stream from a number of digital streams according to one embodiment. Process 400 can be performed by e.g., portable device 102 shown in FIGS. 1 and 2. In some embodiments, the digital streams can be received by portable device 102 over one or more wireless connections (e.g., Bluetooth, WiFi, etc. connections).

Process 400 starts at block 402 when portable device 102 establishes a connection with hearing aid device 116. In some embodiments, portable device 102 can be connected to hearing aid device 116 over a wired connection. In other embodiments, portable device 102 can establish a wireless connection with hearing aid device 116. For example, portable device 102 can be paired with hearing aid device 116 using the Bluetooth protocol. Following the pairing, a secure connection can be established between portable device 102 and hearing aid device 116.

At block 404, portable device 102 can receive a number of digital streams over one or more wireless connections. The digital streams can include audio-only streams and/or audiovisual streams. Illustratively, portable device 102 can receive both the audio and the video frames of a program streamed from a television or just an audio stream. Portable device 102 can receive the number of digital streams over any suitable type of wireless connection. For example, portable device 102 can receive a number of the digital streams over one or more Bluetooth connections. Portable device 102 can additionally receive a number of the digital streams over one or more WiFi connections.

In some embodiments, a digital stream can be received directly from the device from which the stream originates. Illustratively, portable device 102 can receive a digital stream for a movie directly from a television set generating the stream. In other embodiments, a digital stream can be received indirectly from an intermediary. Illustratively, portable device 102 can receive a digital stream for a movie from an access point, which in turn receives the digital stream from a television set generating the stream.

At block 406, portable device 102 can receive a sound or audio sample. In some embodiments, the audio sample can be received from a suitable source, such as a microphone embedded in or externally connected to portable device 102. For example, a microphone embedded in portable device 102 can capture an analog audio sample from the environment surrounding the portable device. The captured audio sample can be any suitable length. For example, the audio sample can be 5, 10, 15, or 30 seconds in duration. In some embodiments, the duration of the audio sample can be sufficient for portable device 102 to select a digital stream based on the audio sample.

At block 408, portable device 102 can match at least some of the digital streams to the received sound or audio sample. For example, portable device 102 can determine, for each received digital stream, a correlation value between the digital stream and a waveform representative of the audio sample. The correlation value between the digital stream and the waveform can be generated using any suitable parameters, criteria, heuristics, etc. For example, portable device 102 can consider certain perceptual characteristics in order to determine a correlation value. For example, portable device 102 can generate a correlation value based on the average zero crossing rate, estimated tempo, average spectrum, spectral flatness, prominence of tones across a set of bands, and the bandwidth of the audio sample and a digital stream.

In some embodiments, the correlation value can also be based on a time offset. In particular, the speed of transfer for a digital stream is typically much faster than the speed at which sound propagates through the air. As a result, portable device 102 can receive a digital stream before receiving the digital stream's analog counterpart (via the audio sample). By comparing the digital stream with the audio sample, portable device 102 can determine an amount of time in which the digital stream and the audio sample are shifted from one another. Based on this shift, portable device 102 can determine a correlation value for the digital stream. In particular, digital streams with smaller shifts can be associated with higher correlation values since, in general, the smaller the shift, the closer the streaming device transmitting a digital stream is to portable device 102.

At block 410, portable device 102 can rank the digital streams based on their correlation to the audio sample. For example, portable device 102 can rank the digital stream in descending order beginning with the digital stream having the greatest correlation to the audio sample.

At block 412, portable device 102 can select one or more digital streams based on the rankings of digital streams. In some embodiments, portable device 102 can automatically select a single digital stream to be transmitted to hearing aid 116. The selected digital stream can be the stream having the greatest correlation to the audio sample.

In other embodiments, portable device 102 can select a set of candidate digital streams. The candidate digital streams can be provided in a ranked list to the user of portable device 102. The user can thereafter select a digital stream from the list to be provided to hearing aid 116. According to some of these embodiments, the candidate digital streams can be those streams with the highest correlation to the audio sample. Illustratively, portable device 102 might rank each of five digital streams according to their correlation to the received audio sample. Based on the ranking, portable device 102 might select the three digital streams with the highest correlation to be referenced in a list presented to the user. In some embodiments, the digital streams in the list can be ranked according to the correlation of each stream to the audio sample.

At block 414, portable device 102 can provide or output the selected digital stream to hearing aid device 116. As discussed, the selected digital stream can either be automatically selected by portable device 102 or selected by the user from a list of candidate digital streams. In some embodiments, the selected digital stream can be provided to hearing aid 116 in the same format and/or structure as received by portable device 102 from a streaming device and/or access point. In other embodiments, portable device 102 can convert or sufficiently alter the selected digital stream such that the stream can be processed by hearing aid device 116. For example, portable device can generate a digital audio output signal that can be used by hearing aid device 116 to generate audio. For example, portable device 102 might receive a digital stream over a WiFi connection and output the digital stream over a Bluetooth connection to hearing aid device 116. As another example, portable device 102 might change the same rate (e.g., resample) a digital stream to match the capabilities of hearing aid device 116. After transmission of the selected digital stream and/or a digital audio output signal, the hearing aid device can project or suitably provide audio to a user based on the provided digital stream and/or output signal.

In certain embodiments, portable device 102 can rank and/or select a digital stream based on the digital stream's association to another stream. For example, a digital stream can be associated with another digital stream if both streams are received from the same source, associated with the same audiovisual program, etc. Illustratively, a streaming device can be configured to transmit three different digital audio streams: one for English, one for Spanish, and one for English “Descriptive Video.” The streaming device, however, might be currently projecting audio from its speakers corresponding to only the English audio stream. During operation, portable device 102 can receive all three digital audio streams from the streaming device as well digital streams from other sources. Upon receiving an audio sample, portable device 102 can determine that the English digital audio stream received from the digital streaming device is most highly correlated to the audio sample. Because the Spanish digital audio stream and the English “Descriptive Video” digital audio stream are also being received from the same source, portable device 102 can similarly associated those streams with high correlation values. In certain embodiments, portable device 102 might automatically, based on a user preference or setting, select and output to hearing aid device 116, the Spanish or the English “Descriptive Video” stream rather than the related English digital audio stream. For example, a user might have provided a setting indicating that any digital audio streams are to be provided in Spanish. In other embodiments, portable device 102 might present a candidate list to a user that includes not only the highly correlated English digital audio stream, but also the Spanish and English “Descriptive Video” digital streams.

In some embodiments, portable device 102 can receive and/or capture additional audio samples following the initial selection of a digital stream. Upon receiving a subsequent audio sample, portable device 102 can once again perform processing to select one or more digital streams.

For example, a user carrying portable device 102 can initially be standing next to a television. Because the user is next to the television, portable device 102 might select a digital stream associated with a program being played on the television. Thereafter, the digital stream associated with the television program can be provided to the hearing aid device. Later, the user might move next to a radio and a subsequent audio sample might be obtained. Thereafter, portable device 102 might select a digital stream associated with a program being played on the radio. The digital stream associated with the radio program can thereafter be provided to the hearing aid device rather than the stream for the television program.

According to some embodiments, portable device 102 can be configured to receive audio samples continually or in periodically. Illustratively, portable device 102 can be configured to receive a new audio sample every 5, 10, 15, or 20 seconds.

In some embodiments, portable device 102 can enable a user to “pin” or lock a digital stream. After pinning a digital stream, portable device 102 can cease receiving additional audio samples and/or selecting digital streams. While continuing to supply audio from the most recently selected digital stream to hearing aid device 116. Illustratively, a user carrying portable device 102 can initially be standing next to a radio. Because the user is next to the radio, portable device 102 might select a digital stream associated with the radio. Thereafter, the user can elect to “pin” the stream. Later, the user might move next to a television. However, because the user previously pinned the digital stream associated with the radio, portable device 102 can continue to provide the digital stream associated with the radio to hearing aid 116. In some embodiments, portable device 102 can resume receiving additional audio samples and/or selecting digital streams after a user has “unpinned” a digital stream. In certain embodiments, portable device 102 can provide a user interface to enable a user to indicate to the portable device whether to receive additional audio samples and/or select digital streams, or to pin a selected digital stream. In some embodiments, the user interface can be provided as a graphical user interface displayed on a touch screen of portable device 102. In other embodiments, the user interface can be a button, switch, etc. embedded in portable device 102.

In certain embodiments, portable device 102 can associate positioning information received and/or collected from any suitable source (e.g., from a magnometer module, GPS module, and/or a three-dimensional gyroscope module) with a selected digital stream and/or a ranking of digital streams. In doing so, when portable device 102 is later in the same position or vicinity (as indicated, for example, by a GPS module), the portable device can select one or more digital streams without being required to match the digital streams to a captured audio sample. Rather, portable device 102 can use a previously selected digital stream and/or a previously generated ranking As a result, the computational resources required to perform a matching between a digital stream and audio sample can be conserved.

According to some embodiments, the selection of the one or more digital streams can additionally or alternatively be based on other attributes, criteria, algorithms, etc. For example, portable device 102 can take into account the signal strength of the wireless connections over which the digital streams are transmitted, the direction in which the portable device is currently pointed, images captured by the portable device, and/or the like.

FIGS. 5-7 show exemplary processes for ranking and/or selecting digital streams based on other attributes, criteria, and/or algorithms. The processes shown in FIGS. 5-7 can be combined with the process shown in FIG. 4 in any suitable manner. For example, the processes shown in FIGS. 5-7 can be used in addition to or as an alternative to blocks 408-410 of process 400 shown in FIG. 4.

Illustratively, portable device 102 can be configured to rank digital streams based on each stream's correlation to a received audio sample. Portable device 102 can additionally be configured to rank digital streams based on the signal strength of the wireless connection over which each digital stream is transmitted. Portable device 102 can thereafter assign suitable weights to each ranking and determine a combined ranking for the digital streams. As another example, portable device 102 can be configured to compute an overall ranking using a suitable algorithm that considers correlation to an audio sample, wireless connection signal strengths, etc. This is in contrast to the former example where rankings for individual criteria are determined and the rankings merged to generate a combined ranking

FIG. 5 is a flow diagram of a process 500 for ranking and/or selecting a digital stream based on the relative signal strengths of the wireless connections through which the number of digital streams are transmitted according to one embodiment. Process 500 can be performed by e.g., portable device 102 shown in FIGS. 1 and 2.

At block 502, portable device 102 can determine the wireless connection with which each of a number of received digital stream is associated. More specifically, portable device 102 can identify the specific wireless connection over which each digital stream is received. Illustratively, portable device 102 can determine that a first digital stream is being received over a Bluetooth connection and that a second digital stream is being received over a WiFi connection.

At block 504, portable device 102 can determine a signal strength for each wireless connection. In some embodiments, the signal strength of each wireless connection can be determined based on measurements and/or other information obtained from portable device's 102 wireless communications modules (e.g., RF module 306, Bluetooth module 304, WiFi module 308, etc.).

At block 506, portable device 102 can rank the wireless connections based, at least in part, on each connection's relative signal strength. In particular, portable device 102 can rank wireless connections with stronger signals higher than wireless connections with weaker signals. By ranking the wireless connections based on signal strength, portable device 102 can more likely determine those streaming devices that are closer or in proximity to the portable device. In some embodiments, because digital streams can be received over a diverse set of wireless connections (e.g., Bluetooth, WiFi, etc.), portable device 102 can normalize the measured signal strengths of each connection such that direct comparisons between the connections can be performed. Based on the rankings one or more digital streams can be selected.

FIG. 6 is a flow diagram of a process 600 for ranking and/or selecting a digital stream based on the direction in which a portable device is pointed according to one embodiment. Process 600 can be performed by e.g., portable device 102 shown in FIGS. 1 and 2.

At block 602, portable device 102 can receive and/or collect information suitable for determining the direction in which the portable device is currently pointed. In some embodiments, the information can be received and/or collected from several different information sources. For example, information can be received and/or collected from a global positioning system (GPS) module, a three-dimensional gyroscope module, a magnometer module, wireless signals, information included within received digital streams, a camera module, network access points, streaming devices, and/or the like.

At block 604, portable device 102 can determine the direction in which the portable device is currently pointed based on the information received and/or collected at block 602. portable device can perform such a determination in any suitable manner and using any combination of received and/or collected information.

According to certain embodiments, portable device 102 can determine the direction in which the portable device is oriented based on, in part, information collected by a magnometer module embedded in or connected to the portable device. In such embodiments, the magnometer module can perform one or more magnetic field measurements. The measurements can be used by portable device 102 to identify the direction in which the device is currently pointed.

According to some embodiments, portable device 102 can determine the direction in which the portable device is pointed based, in part, on the signal strengths of one of more wireless signals. For example, portable device 102 can be configured to determine the signal strengths for one or more wireless signals based on measurements and/or other information collected from portable device's 102 wireless communication modules. Based on the determined signal strengths and other information (e.g., GPS coordinates of wireless devices associated with the wireless signals), portable device 102 can estimate the direction in which the device is currently pointed. More specifically, because wireless signals can be weakened and/or blocked by a user's body, portable device 102 can use a comparison of the relative signal strengths of each wireless signal to estimate which direction portable device 102 is currently facing and/or being pointed.

Referring to FIG. 7, a room can include a television 702 situated on its north side and a radio system 704 situated on its south side. Each of the television and radio system can wirelessly transmit a digital stream directly to portable device 102. As a part of their respective digital streams, the television and radio system can each transmit position information (e.g., GPS coordinates) to portable device 102. During operation, a user of portable device 102 can point the portable device at the radio system. Because the user is likely to face the radio system, the user's body can sufficiently weaken the signal generated from the television such that portable device 102 can determine that the portable device is facing away from the television. Based on this determination and the received GPS coordinates, portable device 102 can determine that the portable device is being pointed in a southern direction.

In one embodiment, portable device 102 can normalize the measured signal strengths to compensate for distance and/or other factors. For example, portable device 102 can be one foot away from a streaming television and two feet away from a streaming radio system. As such, the streaming television can have a stronger signal than the streaming radio by virtue of the fact that the television is closer in proximity to portable device 102. In order to enable the signal strengths to be effectively compared to determine direction, portable device 102 can compensate for the difference in the distances of the streaming devices from the portable device.

As another example, portable device 102 can use measurements of the signal strengths of one or more wireless signals to generate a wireless sensor map. In particular, as a user walks around an environment with portable device 102, measurements of the signal strengths of various wireless signals can be periodically or continuously taken. A wireless sensor map based on the different measured signal strengths for each of the one or more wireless signals can be generated. After the map is generated, portable device 102 can use the map and changes in the signal strengths of the various wireless signals to track the movement and relative positioning of the portable device. Based on this information, portable device 102 can determine a direction in which the device is likely to be pointed. It should be appreciated that while a map can be generated using only signal strength measurements, any suitable information can be used to construct and/or add to the detail of a map. For example, a user can manually edit the map to indicate where streaming sources are located, or portable device 102 can use GPS information received from the streaming sources to determine the location of the sources. The wireless sensor map can be used for the ranking and/or selecting of digital streams as will be shown in block 608.

According to certain embodiments, portable device 102 can use an image captured by a camera embedded in or connected to the portable device to, in part, determine the direction in which the portable device is pointed. Illustratively, portable device 102 can analyze a captured image to identify a subject, such as the user of the portable device. Based on the orientation and position of the subject in the captured image, portable device 102 can determine the end of the portable device pointed away from the user. Such information can be used for the ranking and/or selecting of digital streams as will be shown in block 608.

For example, FIGS. 8a and 8b each show portable device 102 with a device end 804. To aid in understanding, device end 804 can be referred to as the bottom of portable device 102. Referring again to FIGS. 8a and 8b, each figure shows portable device 102 with a different image of a user's face captured by an embedded camera. With respect to FIG. 8a, the user's face is positioned at the bottom of the captured image and oriented in an upright manner. Based on this positioning and orientation of the user's face, portable device 102 can determine that the top of the portable device is pointing away from the user. With respect to FIG. 8b, the user's face is positioned at the top of the captured image and oriented in an upside down manner. Based on this positioning and orientation of the user's face, portable device 102 can determine that the bottom of portable device 102 is pointing away from the user. It should be appreciated that the images shown in FIGS. 8a and 8b are exemplary, and the entirety of a user's face need not be captured. Illustratively, a captured image can include a partial picture of a user's face such as the bottom or underside of a user's chin.

Based on the determination of the end of portable device 102 that is pointing away from a user and other directional information (such as information from a magnometer), portable device 102 can determine the direction in which portable device 102 is being pointed. An advantage of determining direction in this manner is that a user can point portable device 102 in a direction using either end of the portable device.

Referring again to FIG. 6, at block 606, portable device 102 can determine the location of one or more streaming devices or sources of digital streams. In some embodiments, portable device 102 can identify the location of a streaming device by receiving location information (e.g., GPS coordinates) from the streaming device. Illustratively, a digital stream transmitted by a streaming device can include GPS coordinates indicating the location of streaming device. In certain embodiments, portable device 102 can identify the location of a streaming device or other streaming source by associating a digital stream with the known location of another streaming device or other source. Illustratively, portable device 102 might receive information that a television transmitting a digital stream is at a certain location. Portable device 102 might additionally wirelessly receive a digital stream from a radio system. During operation, portable device 102 might determine a correlation between the signal strength of the wireless connection over which the television stream is transmitted and the signal strength of the wireless connection over which the radio stream is transmitted. Illustratively, the signal strengths might both increase when portable device 102 is moved in one direction and decrease as the portable device is moved in the opposite direction. Based on this, portable device 102 might determine that the radio system is in the same location or general area as the television system.

At block 608, portable device 102 can rank the digital streams based, in part, on the determined direction in which the portable device is pointed. In particular, portable device 102 can rank digital streams associated with devices or sources in the direction that the portable device is pointed higher. Illustratively, it can be determined that portable device 102 is currently pointed in the northwest direction. As a result, those digital streams originating from devices situated in the northwest corner of a room can be ranked very high. Based on the rankings, one or more digital streams can be selected.

FIG. 9 is a flow diagram of a process 900 for selecting a digital stream based on an image obtained from a camera according to one embodiment. Process 900 can be performed by e.g., portable device 102 shown in FIGS. 1 and 2.

At block 902, portable device 102 can receive one or more images from a suitable source. For example, portable device 102 can receive the one or more images from a camera embedded in or externally connected to the portable device. At block 904, portable device 102 can analyze the image in order to identify an association between the image and at least one of a number of received digital streams. If an association can be identified, portable device 102 can select the identified digital stream at block 906.

For example, a user might use a camera embedded in portable device 102 to take a picture of a scene of a movie playing on a television. Portable device 102 can thereafter process the picture to identify the specific movie associated with the scene. For example, portable device 102 can employ a suitable image recognition algorithm and/or an image repository to perform the identification. Illustratively, a suitable image recognition algorithm can process the image and query an image repository to attempt to identify a matching movie for the image. After identification of the movie depicted in the image, portable device 102 can then determine whether any of the received digital streams is associated with the movie. Illustratively, portable device 102 can check a movie identifier or metadata included in the streams. If a digital stream associated with the movie is located, portable device 102 can select the digital stream.

As another example, a user might use a camera embedded in portable device 102 to capture an image of another person. Portable device 102 can thereafter process the image in order to identify the specific person portrayed in the image. For example, portable device 102 can store an address book or similar user contact repository. The address book can, in some embodiments, contain information for various people, including contact information, pictures, associated devices, etc. In processing a captured image, portable device 102 can attempt to match the image with a picture stored in the address book. Portable device 102 can attempt to match the image using any suitable image recognition or identification algorithm. If a match is found, portable device 102 can identify the person shown in the captured image. In particular, portable device 102 can determine that the captured image shows the person associated with the picture with which the captured image is matched.

After identifying the specific person in the captured image, portable device 102 can determine whether any received digital streams are associated with person. Illustratively, at least some of the received digital streams can each include an identifier for its transmitting device. Portable device 102 can perform a check to determine whether any of the identifiers for the transmitting devices are associated with the identified person. If an association is found, portable device 102 can select the digital stream for the associated transmitting device.

Such a configuration can enable two users to easily engage in a conversation using digital streams. Illustratively, a first user can take a picture of a second user using the first user's portable device. The first portable device can thereafter select an appropriate digital stream associated with the second user (e.g., a stream transmitted by the second user's portable device). The stream can then be transmitted to a hearing aid device connected to the first portable device.

In some embodiments, a user can take a picture of some other visual marker or identifier using a camera. For example, a user can take a picture of a 1D or 2D barcode affixed to a streaming device. Portable device 102 can thereafter select a digital stream associated with the barcode data captured in the picture. In other instances, a user can take a picture of a company logo. Thereafter, portable device 102 can attempt to match the logo depicted in the picture to a logo included in the metadata of a received digital stream. If a match is identified, portable device 102 can select the matching digital stream.

FIG. 10 is a simplified block diagram of a computer system 1000 that can be used in embodiments of the present invention. For example, various streaming devices and/or access points can incorporate computer system 1000. FIG. 10 is merely illustrative of an embodiment incorporating the present invention and does not limit the scope of the invention as recited in the claims. One of ordinary skill in the art would recognize other variations, modifications, and alternatives.

In one embodiment, computer system 1000 includes processor(s) 1010, random access memory (RAM) 1020, disk drive 1030, communications interface(s) 1060, and a system bus 1080 interconnecting the above components. Other components can also be present. RAM 1020 and disk drive 1030 are examples of tangible media configured to store data such as audio, image, and movie files, operating system code, embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

Embodiments of communications interface 1060 can include computer interfaces, such as include an Ethernet card, wireless interface (e.g., Bluetooth, WiFi, etc.), a modem (telephone, satellite, cable, ISDN), (asynchronous) digital subscriber line (DSL) unit, FireWire interface, USB interface, and the like. For example, communications interface 1060 can include interfaces to connect to a wireless network 1090, and for transmitting and receiving data based over the network.

In various embodiments, computer system 1000 can also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer system 1000 may also include an operating system, such as OS X®, Microsoft Windows®, Linux®, real-time operating systems (RTOSs), embedded operating systems, open source operating systems, and proprietary operating systems, and the like.

While the embodiments described above may make reference to specific hardware and software components, those skilled in the art will appreciate that different combinations of hardware and/or software components may also be used and that particular operations described as being implemented in hardware might also be implemented in software or vice versa.

Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Computer programs incorporating various features of the present invention may be encoded on various computer readable storage media; suitable media include magnetic disk or tape, optical storage media such as compact disk (CD) or DVD (digital versatile disk), flash memory, and the like. Computer readable storage media encoded with the program code may be packaged with a compatible device or provided separately from other devices. In addition program code may be encoded and transmitted via wired optical, and/or wireless networks conforming to a variety of protocols, including the Internet, thereby allowing distribution, e.g., via Internet download.

Thus, although the invention has been described with respect to specific embodiments, it will be appreciated that the invention is intended to cover all modifications and equivalents within the scope of the following claims.

What is claimed is:

1. A method for selecting a digital audio input signal using a portable device having a microphone, the method comprising:
receiving, at the portable device, a plurality of digital audio input signals, each digital audio input signal being received via a wireless connection;
detecting, by the portable device, a sound via the microphone;
comparing, by the portable device, the detected sound to the digital audio input signals; and
selecting, by the portable device, one or more of the digital audio input signals based on at least in part the comparing.

2. The method of claim 1, wherein the selecting includes identifying one of the digital audio input signals as a best match signal to the detected sound based on at least in part the comparing; and selecting at least the best match digital audio input signal.

3. The method of claim 1, wherein the selecting includes ranking the digital audio input signals based on at least in part the comparing and selecting one or more of the digital audio input signals based on at least in part the ranking

4. The method of claim 3, further comprising:
presenting, by the portable device, a ranked listing of the one or more selected digital audio input signals to a user; and
receiving, by the portable device, an input from the user selecting a one of the one or more selected digital audio input signals.

5. The method of claim 4, wherein the number of selected digital audio input signals is less than the number of the plurality of received digital audio input signals.

6. The method of claim 1, further comprising:
generating, by the portable device, a digital audio output signal based on at least in part the selected one or more digital audio input signals; and
transmitting, by the portable device, the digital audio output signal to a hearing aid device.

7. The method of claim 1, further comprising determining a signal strength for each wireless connection via which each of the plurality of digital audio input signals is received; and
wherein selecting the one or more of the digital audio input signals is further based on at least in part the signal strength of each wireless connection via which each of the digital audio input signals is received.

8. The method of claim 1, further comprising determining a direction in which the portable device is pointed; and
wherein selecting the one or more of the digital audio input signals is further based on at least in part the direction in which the portable device is pointed.

9. The method of claim 1, further comprising:
obtaining an image from a camera; and
wherein selecting the one or more of the digital audio input signals is further based on at least in part the obtained image.

10. A portable device comprising:
a wireless interface;
a microphone configured to capture a sound sample from an environment surrounding the portable device; and
a processor coupled to the wireless interface and the microphone, the processor configured to:
receive a digital stream via the wireless interface; and
transmit the digital stream to a connected hearing aid device based at least in part on the sound sample captured by the microphone.

11. The portable device of claim 10, wherein the processor is further configured to compute a first correlation between the digital stream and the captured sound sample.

12. The portable device of claim 11, wherein the processor is further configured to compute a second correlation between another digital stream and the captured sound sample.

13. The portable device of claim 12, wherein transmitting the digital stream based at least in part on the sound sample includes determining that the first correlation is higher than the second correlation; and transmitting the digital stream based on at least in part the determination.

14. The portable device of claim 10, wherein the processor is further configured to:
display a list including the digital stream; and
receive an indication from the user selecting the digital stream.

15. The portable device of claim of claim 10, wherein the processor is further configured to:
determine a signal strength for a wireless signal associated with the digital stream; and
wherein the digital stream is transmitted to the hearing aid device based on at least in part the signal strength for the wireless signal.

16. The portable device of claim of claim 10, wherein the processor is further configured to:
generate a wireless sensor map based on at least in part one or more measurements;
identifying a direction in which the portable device is oriented based on at least in part the generated wireless sensor map; and
wherein the digital stream is transmitted to the hearing aid device based on at least in part the identified direction in which the portable device is oriented.

17. The portable device of claim of claim 10, wherein the processor is further configured to:
receive image data from an input source;
identify a subject based on at least in part the received image data;
determine an association between the identified subject and the digital stream; and
wherein the digital stream is transmitted to the hearing aid device based on at least in part the association between the identified subject and the digital stream.

18. The portable device of claim of claim 17, wherein the identified subject is a person.

19. The portable device of claim of claim 18, wherein the digital stream is received from a device associated with the identified person.

20. A non-transitory computer-readable medium having stored instructions, thereon, which, when executed by a processor of a portable device, causes the processor to perform operations comprising:
establishing a connection between the portable device and a hearing aid device;
receiving a plurality of digital audio input signals, each digital audio input signal being received via a wireless connection;
receiving an audio sample from a microphone;
determining a correlation between each of the plurality of digital audio input signals and the received audio sample;
determining the signal strength of one or more wireless signals;
selecting at least one digital audio input signal based on at least in part:
the determined correlation between the digital audio input signal and the received audio sample; and
the determined signal strengths of the one or more wireless signals;
generating a digital audio output signal based on the at least one selected digital audio input signal; and
transmitting the digital audio output signal to the hearing aid device.

21. The non-transitory computer-readable medium of claim 20, the instructions further causing the processor to perform operations comprising:
receiving location information for at least one digital signal source associated with one or more of the plurality of digital audio input signals;
receiving measurement information from one or more measurement sources;
determining a direction in which the portable device is pointed based on at least in part the measurement information; and
wherein selecting at least one digital audio input signal is further based on at least in part the location information for the at least one digital signal sources and the determined direction in which the portable device is pointed.

22. The non-transitory computer-readable medium of claim 20, wherein the measurement information includes magnetic field measurement data.

23. A method comprising:
receiving one or more digital audio streams;
receiving an image from a camera; and
selecting a digital audios stream from the one or more digital audio streams based on at least in part the received image.

24. The method of claim 23, wherein the selecting includes:
determining an association between the received image and a digital audio stream; and
selecting the digital audio stream based on at least in part the association.

25. The method of claim 24, wherein the received image depicts a frame of a video and wherein the selected digital audio stream is a digital audio stream associated with the video.
